(19) United States
(12) Patent Application Publication
(10) Pub. No.: US 2020/0257662 A1
(43) Pub. Date: Aug. 13, 2020

(54) Junk Feature Acquisition Method, Apparatus, Server and Readable Storage Medium

(71) Applicant: Beijing Kingsoft Internet Security Software Co., Ltd., Beijing (CN)

(72) Inventors: Kangzong Zhang, Beijing (CN); Sina Ma, Beijing (CN); Shengjin Deng, Beijing (CN); Wenjie Guo, Beijing (CN)

(21) Appl. No.: 16/648,965

(22) PCT Filed: Apr. 28, 2018
(86) PCT No.: PCT/CN2018/084992

§ 371 Date: Mar. 19, 2020

(30) Foreign Application Priority Data
Sep. 21, 2017 (CN) 201710860431.9

(51) Int. Cl. G06F 16/174; G06F 16/13

(52) U.S. Cl. CPC G06F 16/1748; G06Q 30/0277; G06F 16/1744; G06F 16/13

(57) ABSTRACT

Provided in embodiments of the present application are a junk feature acquisition method, an apparatus, a server and a readable storage medium. The method is used on a first server, and the method comprises: obtaining storage paths to be analyzed; storage paths to be analyzed being: a storage path of a file corresponding to an application (app) installed on an electronic device; filtering out a target storage path out of the storage paths to be analyzed, the target storage path comprising: a storage path matching a file feature of a non-junk file in a pre-determined white list; making a storage path obtained by filtering into a junk feature. Using a method provided in an embodiment of the present application to acquire a junk feature can increase junk feature acquisition effectiveness and decrease labor consumption.

The present application claims the priority to a Chinese patent application No. 201710860431.9 filed with the China National Intellectual Property Administration on Sep. 21, 2017 and entitled “Junk feature acquisition method, apparatus, server and readable storage medium”, which is incorporated herein by reference in its entirety.

### TECHNICAL FIELD

The present application relates to the field of computer technology, and in particular, to a junk feature acquisition method, device, server and readable storage medium.

### BACKGROUND

At present, users often install various APPs (Applications) in an electronic device to use the installed APPs to listen to songs, watch news, chat, and so on. However, during the process of installing and using an APP, the APP creates various files on the electronic device, and many of these files are junk files, such as advertisement files, which makes storage resources of the electronic device are largely occupied by the junk files.

In the prior art, in order to release storage resources occupied by the junk files, technicians need to manually review all files created by each APP installed on an electronic device, to determine the file features of the junk files generated by each APP, which may also be called junk features (for example, file name of the advertising files generated by the APP is taken as junk features), and then junk features corresponding to each of APPs are provided to a junk cleaning APP, so that the junk cleaning APP can clean the junk files generated by the corresponding APPs based on the junk features.

However, there are many different types of APPs, and a large of new APPs are released every day. The above manner of obtaining junk features of junk files generated by each APP through manual analysis requires a lot of manpower and is inefficient.

### SUMMARY

The purpose of the embodiment of the present application is to provide a junk feature acquisition method, device, server and readable storage medium, so as to improve the acquisition efficiency of junk features and reduce manpower consumption.

In a first aspect, an embodiment of the present application provides a junk feature acquisition method, applied to a first server. The method includes:

obtaining storage paths to be analyzed; the storage paths to be analyzed comprise a storage path of a file corresponding to an application APP installed in an electronic device;

filtering out a target storage path from the storage paths to be analyzed, wherein the target storage path comprises: a storage path matching a file feature of a non-junk file in a preset white list:

taking a resulting storage path obtained after filtering as a junk feature.

Optionally, the file feature in the preset white list is: a file feature of a file that ensures the normal operation of a preset APP; the step of taking a resulting storage path obtained after filtering as a junk feature comprises:

determining whether the resulting storage path carries a preset APP identifier of the preset APP;

if the resulting storage path carries a preset APP identifier, taking the resulting storage path carrying the preset APP identifier as a junk feature corresponding to the preset APP.

Optionally, after the step of obtaining the storage paths to be analyzed, the step may also include:

acquiring a model identifier of the electronic device corresponding to the storage paths to be analyzed, and storing the model identifier in correspondence with the storage paths to be analyzed;

the step of taking the resulting storage path carrying the preset APP identifier as a junk feature corresponding to the preset APP comprises:

determining a target model identifier corresponding to the resulting storage path carrying the preset APP identifier;

taking the resulting storage path carrying the preset APP identifier as: a junk feature corresponding to the preset APP in an electronic device corresponding to the target model identifier.

Optionally, if it is determined that the resulting storage path does not carry the preset APP identifier of the preset APP, the method may further include:

determining a target APP identifier carried in the resulting storage path;

determining whether the number of occurrences of the resulting storage path carrying the target APP identifier exceeds a preset number of occurrences:

if it exceeds the preset number of occurrences, adding a target file feature into the preset white list; wherein the target file feature is a file feature of a file that ensures the normal operation of a target APP corresponding to the target APP identifier.

Optionally, in one embodiment of the present application, the step of obtaining the storage paths to be analyzed may include:

obtaining sub-storage paths under a preset storage path in the electronic device; the preset storage path is: an installation path of the APP in the electronic device;

taking the obtained sub-storage paths as the storage paths to be analyzed.

Optionally, the step of taking the obtained sub-storage path as storage paths to be analyzed may include:

pre-processing the obtained sub-storage paths based on a pre-processing rule to obtain pre-processed sub-storage paths; wherein, the pre-processing rule comprises: performing deduplication of a sub-storage path that repeatedly occurs, and/or, filtering out a sub-storage path containing a preset language text from the sub-storage paths;

taking the pre-processed sub-storage paths as the storage paths to be analyzed.

Optionally, in another embodiment of the present application, the step of obtaining the storage paths to be analyzed may include:

monitoring whether a compressed file is generated by a second server; wherein the compressed file is obtained by compressing the storage paths to be analyzed;

if the compressed file is generated, pulling the compressed file from the second server:

decompressing the compressed file to obtain the storage paths to be analyzed.

Optionally, in another embodiment of the present application, the step of obtaining the storage paths to be analyzed may include:

obtaining storage paths regularly sent by the junk cleaning APP in the electronic device as the storage paths to be analyzed.

Optionally, after the step of taking a resulting storage path obtained after filtering as a junk feature, the step may also include:

sending the junk feature to the junk cleaning APP, so that the junk cleaning APP detects a file corresponding to the junk feature based on the junk feature:

determining whether the size of a file corresponding to the junk feature detected based on the junk feature increases;

if the size increases, taking the junk feature as an effective junk feature.

Optionally, in the embodiment of the present application, the target storage path further includes: a storage path matching file features in a preset black list.

Optionally, in the embodiment of the present application, the file features in the preset black list include: a preset cache identifier and a preset advertisement identifier.

In a second aspect, an embodiment of the present application further provides a junk feature acquisition apparatus, which is applied to the first server. The apparatus includes:

a first obtaining unit, configured for obtaining storage paths to be analyzed; the storage paths to be analyzed comprise a storage path of a file corresponding to an application APP installed in an electronic device:

a filtering unit, configured for filtering out a target storage path from the storage paths to be analyzed, the target storage path comprises: a storage path matching a file feature of a non-junk file in a preset white list:

a second obtaining unit, configured for taking the resulting storage path as a junk feature.

Optionally, the file feature in the preset white list is: a file feature of a file that ensures the normal operation of a preset APP; the second obtaining unit may include:

a first judging sub-unit, configured for determining whether the resulting storage path carries a preset APP identifier of the preset APP;

a first obtaining sub-unit, configured for taking, when the resulting storage path carries a preset APP identifier, the resulting storage path carrying the preset APP identifier as a junk feature corresponding to the preset APP.

Optionally, in the embodiment of the present application, the apparatus may also include:

a third obtaining unit, configured for acquiring, after obtaining the storage paths to be analyzed, a model identifier of the electronic device corresponding to the storage paths to be analyzed, and storing the model identifier in correspondence with the storage paths to be analyzed.

Correspondingly, the second obtaining unit may be specifically configured for:

determining a target model identifier corresponding to the resulting storage path carrying the preset APP identifier;

taking the resulting storage path carrying the preset APP identifier as: a junk feature corresponding to the preset APP in an electronic device corresponding to the target model identifier.

Optionally, in the embodiment of the present application, the apparatus may also include:

a first determining unit, configured for determining, when it is determined that the resulting storage path does not carry the preset APP identifier of the preset APP, a target APP identifier carried in the resulting storage path;

a first judging unit, configured for determining whether the number of occurrences of the resulting storage path carrying the target APP identifier exceeds a preset number of occurrences:

an adding unit, configured for adding, when the number of occurrences of the resulting storage path carrying the target APP identifier exceeds the preset number of occurrences, a target file feature into the preset white list; wherein the target file feature is a file feature of a file that ensures the normal operation of a target APP corresponding to the target APP identifier.

Optionally, in one embodiment of the present application, the first obtaining unit may include:

a second obtaining sub-unit, configured for obtaining sub-storage paths under a preset storage path in the electronic device, the preset storage path is: an installation path of the APP in the electronic device;

a second obtaining sub-unit, configured for taking the obtained sub-storage paths as the storage paths to be analyzed.

Optionally, in the embodiment of the present application, the second obtaining sub-unit may be specifically configured for:

pre-processing the obtained sub-storage paths based on a pre-processing rule to obtain pre-processed sub-storage paths; wherein, the pre-processing rule comprises: performing deduplication of a sub-storage path that repeatedly occurs, and/or, filtering out a sub-storage path containing a preset language text from the sub-storage paths;

taking the pre-processed sub-storage paths as the storage paths to be analyzed.

Optionally, in another embodiment of the present application, the first obtaining unit may include:

a monitoring sub-unit, configured for monitoring whether a compressed file is generated by a second server; wherein the compressed file is obtained by compressing the storage paths to be analyzed:

a pulling sub-unit, configured for pulling, when the compressed file is generated, the compressed file from the second server;

a decompressing sub-unit, configured for decompressing the compressed file to obtain the storage paths to be analyzed.

Optionally, in another embodiment of the present application, the first obtaining unit may be specifically configured for:

obtaining storage paths regularly sent by the junk cleaning APP in the electronic device as the storage paths to be analyzed.

Optionally, in the embodiment of the present application, the apparatus may also include:

a sending unit, configured for sending, after taking a resulting storage path obtained after filtering as a junk feature, the junk feature to the junk cleaning APP, so that the junk cleaning APP detects a file corresponding to the junk feature;

a second judging unit, configured for determining whether the size of the detected file increases:

a fourth obtaining unit, configured for taking, when the size of the detected file increases, the junk feature as a junk feature for deleting junk files.

Optionally, the target storage path further includes: a storage path matching file features in a preset black list.

Optionally, the file features in the preset black list include: a preset cache identifier and a preset advertisement identifier.

In a third aspect, an embodiment of the present application provides a server comprising a processor, a communication interface, a memory and a communication bus, and the processor, the communication interface and the memory communicate with each other via the communication bus;

the memory is configured for storing a computer program;

the processor is configured for implementing method steps of the junk feature acquisition method provided by any one of the foregoing method embodiments when executing the program stored in the memory.

In a fourth aspect, an embodiment of the present application further provides a readable storage medium. A computer program is stored in the readable storage medium, and the method steps of the junk feature acquisition method provided by any one of the foregoing method embodiments are implemented when the computer program being executed by a processor.

In a fifth aspect, an embodiment of the present application further provides a computer program product containing instructions, which when executed on a server, causes the server to execute: the method steps of the junk feature acquisition method provided by any one of the foregoing method embodiments.

In the embodiment of the present application, the storage paths to be analyzed may be obtained through a first server, that is, the storage path of the file corresponding to the APP installed in the electronic device is obtained. Then a storage path matching a file feature of a non-junk file in the preset white list are filtered out from the storage paths to be analyzed, and the resulting storage paths are considered to be the storage paths corresponding to the junk files. Since the junk files under the storage path can be found through the resulting storage path, the resulting storage path can be used as a junk feature, so that the obtained junk feature can be used later to find the corresponding junk files. In this way, the efficiency of acquiring junk feature is improved.

In addition, the manpower consumption is reduced, thereby reducing the cost of obtaining junk features.

### BRIEF DESCRIPTION OF THE DRAWINGS

In order to explain the technical solutions in the embodiments of the present application or the prior art more clearly, the drawings used in the embodiments or the description of the prior art will be briefly introduced below. Obviously, the drawings described below are for only some embodiments of the present application, one of ordinary skills in the art can also obtain other drawings based on these drawings without any creative efforts.

FIG. 1 is a flowchart of a junk feature acquisition method provided by an embodiment of the present application:

FIG. 2 is a flowchart of another junk feature acquisition method provided by an embodiment of the present application:

FIG. 3 is a schematic structural diagram of a junk feature acquisition method provided by an embodiment of the present invention;

FIG. 4 is a schematic structural diagram of a server provided by an embodiment of the present application.

### DETAILED DESCRIPTION

The technical solution of the application will be described in detail with reference to the drawings of embodiments of the present application. Obviously, the embodiments described are only some instead of all of the embodiments of the present application. All other embodiments obtained by those of ordinary skills in the art based on the embodiments herein without any creative efforts are within the scope of the present application.

In order to solve problems in the prior art, the embodiment of the present application provide a junk feature acquisition method, apparatus, server and readable storage medium.

The junk feature acquisition method provided in the embodiment of the present application is described below first.

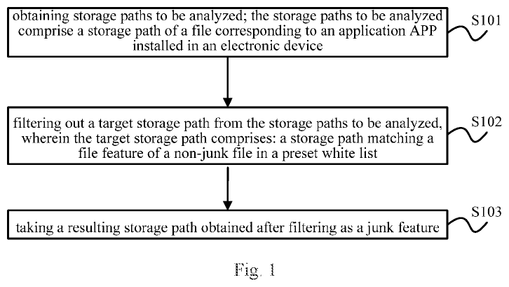

Referring to FIG. 1, the junk feature acquisition method provided by the embodiment of the present application is applied to a first server. The method includes the following steps:

S101: obtaining storage paths to be analyzed; the storage paths to be analyzed comprise a storage path of a file corresponding to an application APP installed in an electronic device;

S102: filtering out a target storage path from the storage paths to be analyzed, wherein the target storage path comprises: a storage path matching a file feature of a non-junk file in a preset white list;

S103: taking a resulting storage path obtained after filtering as a junk feature.

In the prior art, technicians need to review the files corresponding to the APP generated during the installation and use of the APP (Application) one by one, and then find out junk files in these files. Furthermore, an artificial analysis is performed for each junk file, and representative file features (such as the advertisement name of the advertisement file) obtained by the artificial analysis are taken as the junk features of the corresponding junk files. The manner of obtaining junk features requires a lot of manpower and is inefficient.

In order to solve the above problem, in the embodiment of the present application, the storage paths to be analyzed may be obtained through a first server, that is, a storage path of a file corresponding to the APP installed in the electronic device is obtained. Then a storage path matching a file feature of a non-junk file in the preset white list are filtered from the storage paths to be analyzed, and the resulting storage paths are considered to be the storage paths corresponding to the junk files. Since the junk files under the storage path can be found through the resulting storage path, the resulting storage path can be used as a junk feature, so that the obtained junk feature can be used later to find the corresponding junk files. In this way, the efficiency of acquiring junk feature is improved. In addition, the manpower consumption is reduced, thereby reducing the cost of obtaining junk features.

Wherein, the electronic device includes, but is not limited to, a mobile phone and a tablet computer capable of installing APPs. Those skilled in the art can understand that the resulting storage path obtained after filtering refers to a storage path other than the target storage path among the obtained storage paths to be analyzed.

The junk feature acquisition method provided in the embodiment of the present application will be described in detail below with reference to specific examples.

Assume that APP1 is installed in an electronic device A, and file 1, file 2, . . . , file N corresponding to the APP1 are generated during the installation and use of the APP1, and it is known that file 1 and file 2 are non-junk files of the APP1 file. In this way, when it is necessary to obtain junk features corresponding to the junk files generated by APP1 in the electronic device A, the file feature of file 1 and the file feature of file 2 can be used as data in a preset white list.

Wherein, the file feature of the file 1 may be a storage path of the file 1 in the electronic device A, or of course, it may be a file identifier of file 1 that can uniquely identify the file 1, such as a part of the file 1 in the storage path in the electronic device A, this is reasonable. Similarly, the file feature of the file 2 may also be a storage path of the file 2 in the electronic device A or a file identifier of file 2, which is not described in detail herein.

In this way, a first server may obtain a storage path of the file corresponding to APP1 installed in the electronic device A: the storage path of file 1, the storage path of file 2, . . . , the storage path of file N, and these storage paths can be used as storage paths to be analyzed. Then, based on the preset white list, a storage path matching a file feature recorded in the preset white list is filtered from the storage paths to be analyzed, and the resulting storage path is considered to be the storage path corresponding to the junk files. Wherein, since files under the storage path can be found through the storage path, the resulting storage path may be used as the junk feature of the corresponding junk file. In this way, it is not necessary to obtain junk features through manual modes for technicians, which improves the speed of acquiring junk features.

Wherein the first server may directly obtain sub-storage paths from the preset storage path of the electronic device A: a storage path of file 1, a storage path of file 2, . . . , a storage path of file N, and then it is determined whether these sub-storage paths carry a preset language text (e.g. Burmese). It is assumed that Burmese appears in the storage path of file 10, then it is reasonable to filter out the storage path of file 10 and then use the remaining sub-storage paths as storage paths to be analyzed.

Wherein the preset storage path is an installation path of APP1 in the electronic device A. Specifically, the preset storage path may be: /android/data/, android/obb/, and dada/data/, which is of course not limited to this.

Of course, the first server may also obtain the storage paths to be analyzed from the second server. For example, the junk cleaning APP in the electronic device A may regularly obtain storage paths of files corresponding to APP1 in the electronic device A: a storage path of file 1, a storage path of file 2, . . . , a storage path of file N. In addition, the junk cleaning APP may send the obtained storage paths to the second server. In this way, the second server may directly use the received storage paths as the storage paths to be analyzed; it may also pre-process the received storage paths according to a pre-processing rule, and then the storage path obtained after preprocessing is used as the storage paths to be analyzed, which can reduce the number of storage paths to be analyzed. After that, the second server may also compress the obtained storage paths to be analyzed to obtain a compressed file. Meanwhile, the first server may monitor whether a compressed file is generated by the second server, and if it is detected that a compressed file is generated, then the compressed file is pulled from the second server. Since the compressed file is pulled, transmission loss of the first server to obtain the storage paths to be analyzed can be greatly reduced. After that, the first server may decompress the compressed file, so as to obtain the storage paths to be analyzed.

In the above manner, the storage paths to be analyzed is stored by using one server and the storage paths to be analyzed is analyzed by using another server, so that operations of storing and processing the storage paths to be analyzed are performed separately, which reduces the processing pressure of the first server. Furthermore, after the compressed file is generated by the second server, the compressed file may also be locked as a lock file, which can avoid the compressed file being overwritten by other files, so that the first server can successfully pull the compressed file, thereby ensuring acquisition of junk features.

Wherein, the pre-processing rule may include: filtering out a sub-storage path containing a preset language text from the sub-storage paths, which is of course not limited to this.

It should be noted that the above description is only an example. In addition to APP1, APP2, APP2, APP3, etc. may also installed in the electronic device A.

Then it may be assumed that in addition to APP1, APP2 is installed in the electronic device A. and it may be assumed that only file features of the non-junk files corresponding to APP1 are recorded in the preset white list. In addition, the feature features of the non-junk files corresponding to APP1 may be: feature features that ensure the normal operation of the APP1.

In this case, since the storage paths to be analyzed obtained by the first server is: a storage path of files corresponding to APP1 and APP2 installed in the electronic device A. Therefore, in order to avoid subsequent identification of the files corresponding to APP2 as junk files, it can be determined whether the resulting storage path carries an identifier of APP1 (for example, name of APP1). If it is carried, it is considered that the resulting storage path is the storage path of the junk files generated by the APP1, and the resulting storage path may be used as the junk feature corresponding to the APP1.

Conversely, if the resulting storage path does not carry an identifier of APP1, the resulting storage path is not considered to be the storage path of the junk files generated by APP1. At this time, the target APP identifier carried in the resulting storage path may be determined. When it is determined that the target APP identifier carried in the resulting storage path is: APP2, it can be determined whether the number of occurrences of the resulting storage path carrying the APP2 identifier exceeds a preset number of occurrences. If it exceeds the preset number of occurrences, it indicates that APP2 is installed in many electronic devices. Therefore, the file features of the file that ensure the normal operation of APP2 may be added to a preset white list. In this way, when a storage path of a file corresponding to the APP2 is received next time, junk features corresponding to the APP2 can be obtained.

Wherein, the identifier of APP1 and the identifier of APP2 may be set according to specific conditions of the corresponding APP, and which will not be described in detail herein. Similarly, the preset number of times may also be set according to specific conditions, and details are not described herein.

It can be understood that, in addition to the storage path of the file corresponding to the APP installed in the electronic device A, the first server may also obtain storage paths of files corresponding to APPs installed in a large number of electronic devices such as the electronic device B, the electronic device C, and the electronic device D.

Then, it may be assumed that the first server can obtain storage paths of files corresponding to APPs installed in the electronic device A, the electronic device B. and the electronic device C. And it is assumed that APP1 and APP2 are installed in the electronic device A. APP1 is installed in the electronic device B and the electronic device C, and the electronic device A and the electronic device B belong to the same model of electronic device, and the electronic device A and the electronic device C belong to different models of electronic devices. And it is assumed that the storage path of the file created by APP1 in the electronic device A is different from the storage path of the file created by APP1 in the electronic device C.

Therefore, in order to avoid the subsequent use of the junk features corresponding to APP1 in the electronic device A, when the junk features generated by APP1 in the electronic device C are cleaned, it is impossible to achieve junk cleaning. In the embodiment of the present application, the first server may also acquire, after obtaining the storage paths to be analyzed, a model identifier of the electronic device corresponding to the storage paths to be analyzed, and store the model identifier in correspondence with the storage paths to be analyzed. Then, a model identifier corresponding to each resulting storage path is determined, so as to determine which electronic device the obtained junk features are suitable for. The model identifier includes, but is not limited to, electronic device version information.

Specifically, when storage paths to be analyzed obtained by the first server are: a storage path of files corresponding to APP1 and APP2 installed in electronic device A, a storage path of files corresponding to APP1 installed in electronic device B, and a storage path of files corresponding to APP1 installed in electronic device C, the electronic device A and the electronic device B belong to the same electronic device, therefore the storage path of the files corresponding to APP1 installed in the electronic device A is the same as that of the APP1 installed in the electronic device B. In order to avoid multiple analyses of the same storage path, the repeated storage path may be deduplicated.

Then, the storage path of files corresponding to APP1 and APP2 installed in the electronic device A and the storage path of files corresponding to APP1 installed in the electronic device C obtained by deduplication are filtered by using a preset white list, to obtain the resulting storage paths. Then, an APP identifier and a model identifier corresponding to each resulting storage path are determined, so as to determine the electronic device and APP that each junk feature is suitable for.

In addition to using the preset white list to filter the storage paths obtained after deduplication processing, a preset black list may also be used to filter the storage path obtained by filtering using the preset white list again. In this way, file features of junk files unknown to those skilled in the art, that is, unknown junk features may be obtained. The preset black list may record file features of junk files known to those skilled in the art, specifically, the file features of the preset black list may include a preset cache identifier and a preset advertisement identifier, and which is of course not limited to this.

Furthermore, after using the resulting storage path obtained after filtering by the preset white list and the preset black list as junk features, in order to ensure the effectiveness of the resulting junk features, that is, to ensure that the files found by the junk features are junk files. The resulting junk features may also be sent to a junk cleaning APP in an electronic device for testing the effectiveness of junk features. So that the junk cleaning APP detects a file corresponding to each junk feature, and determines whether the size of the detected file corresponding to each junk feature is increased. If it increases, the junk feature is provided as an effective junk feature to the junk cleaning APP to clean up junk files. If it is not increased, the junk features is deleted. Of course, the operation of determining whether the size of the detected file corresponding to each detected junk feature is increased and the operation of providing the junk feature as an effective junk feature to the junk cleaning APP to clean up junk files when the size is increased may also be performed by the first server, it is reasonable.

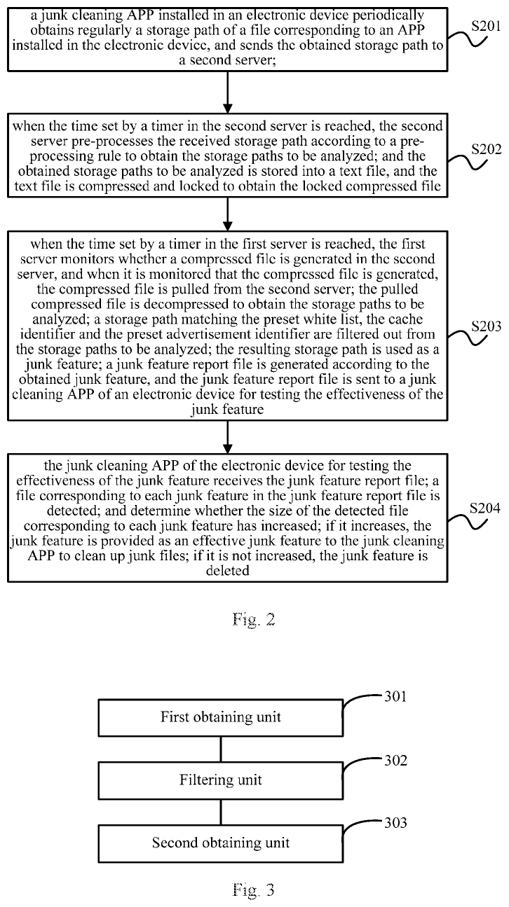

Another junk feature acquisition method provided in the embodiment of the present application is described below with reference to FIG. 2.

Referring to FIG. 2, the junk feature acquisition method provided by the embodiment of the present application may include the following steps:

S201: a junk cleaning APP installed in an electronic device periodically obtains a storage path of a file corresponding to an APP installed in the electronic device, and sends the obtained storage path to a second server:

S202: when the time set by a timer in the second server is reached, the second server pre-processes the received storage path according to a pre-processing rule to obtain the storage paths to be analyzed; and the obtained storage paths to be analyzed is stored into a text file, and the text file is compressed and locked to obtain the locked compressed file:

S203: when the time set by a timer in the first server is reached, the first server monitors whether a compressed file is generated in the second server, and when it is monitored that the compressed file is generated, the compressed file is pulled from the second server; the pulled compressed file is decompressed to obtain the storage paths to be analyzed; a storage path matching the preset white list, the cache identifier and the preset advertisement identifier are filtered out from the storage paths to be analyzed; the resulting storage path is used as a junk feature; a junk feature report file is generated according to the obtained junk feature, and the junk feature report file is sent to a junk cleaning APP of an electronic device for testing the effectiveness of the junk feature;

S204: the junk cleaning APP of the electronic device for testing the effectiveness of the junk feature receives the junk feature report file; a file corresponding to each junk feature in the junk feature report file is detected; and determine whether the size of the detected file corresponding to each junk feature has increased; if it increases, the junk feature is provided as an effective junk feature to the junk cleaning APP to clean up junk files; if it is not increased, the junk feature is deleted.

In summary, the embodiment of the present application is applied to improve the efficiency of obtaining junk features and reduce the manpower consumption.

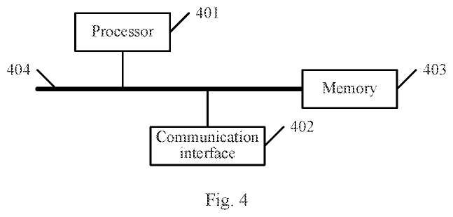

Corresponding to the above method embodiment, an embodiment of the present application further provides a junk feature acquisition apparatus, which is applied to the first server. Referring to FIG. 3, the apparatus includes:

a first obtaining unit 301, configured for obtaining storage paths to be analyzed; the storage paths to be analyzed comprise a storage path of a file corresponding to an application APP installed in an electronic device;

a filtering unit 302, configured for filtering out a target storage path in the storage paths to be analyzed, the target storage path includes: a storage path matching a file feature of a non-junk file in a preset white list;

a second obtaining unit 303, configured for taking the resulting storage path as a junk feature.

In the embodiment of the present application, the storage paths to be analyzed may be obtained through a first server, that is, the storage path of the file corresponding to the APP installed in the electronic device is obtained. Then a storage path matching a file feature of a non-junk file in the preset white list are filtered out from the storage paths to be analyzed, and the resulting storage paths are considered to be the storage paths corresponding to the junk files. Since the junk files under the storage path can be found through the resulting storage path, the resulting storage path can be used as a junk feature, so that the obtained junk feature can be used later to find the corresponding junk files. In this way, the efficiency of acquiring junk feature is improved. In addition, the manpower consumption is reduced, thereby reducing the cost of obtaining junk features.

Optionally, the file features in the preset white list are: files features of files that ensure the normal operation of a preset APP; the second obtaining unit 303 may include:

a first judging sub-unit, configured for determining whether the resulting storage path carries a preset APP identifier of the preset APP;

a first obtaining sub-unit, configured for taking, when the resulting storage path carries a preset APP identifier, the resulting storage path carrying the preset APP identifier as a junk feature corresponding to the preset APP.

Optionally, in the embodiment of the present application, the apparatus may also include:

a third obtaining unit, configured for acquiring, after obtaining the storage paths to be analyzed, a model identifier of the electronic device corresponding to the storage paths to be analyzed, and storing the model identifier in correspondence with the storage paths to be analyzed;

Correspondingly, the second obtaining unit 303 is specifically configured for:

determining a target model identifier corresponding to the resulting storage path carrying the preset APP identifier;

taking the resulting storage path carrying the preset APP identifier as: a junk feature corresponding to the preset APP in an electronic device corresponding to the target model identifier.

Optionally, in the embodiment of the present application, the apparatus may also include:

a first determining unit, configured for determining, when it is determined that the resulting storage path does not carry the preset APP identifier of the preset APP, a target APP identifier carried in the resulting storage path:

a first judging unit, configured for determining whether the number of occurrences of the resulting storage path carrying the target APP identifier exceeds a preset number of occurrences;

an adding unit, configured for adding, when the number of occurrences of the resulting storage path carrying the target APP identifier exceeds the preset number of occurrences, a target file feature into the preset white list; wherein the target file feature is a file feature of a file that ensures the normal operation of a target APP corresponding to the target APP identifier.

Optionally, in one embodiment of the present application, the first obtaining unit 301 may include:

a second obtaining sub-unit, configured for obtaining sub-storage paths in a preset storage path in the electronic device; the preset storage path is: an installation path of the APP in the electronic device:

a second obtaining sub-unit, configured for taking the obtained sub-storage paths as the storage paths to be analyzed.

Optionally, in the embodiment of the present application, the second obtaining sub-unit is specifically configured for:

pre-processing the obtained sub-storage paths based on a pre-processing rule to obtain pre-processed sub-storage paths; wherein, the pre-processing rule comprises: performing deduplication of a sub-storage path that repeatedly occurs, and/or, filtering out a sub-storage path containing a preset language text from the sub-storage paths;

taking the pre-processed sub-storage paths as the storage paths to be analyzed.

Optionally, in another embodiment of the present application, the first obtaining unit 301 may include:

a monitoring sub-unit, configured for monitoring whether a compressed file is generated by a second server; wherein the compressed file is obtained by compressing the storage paths to be analyzed:

a pulling sub-unit, configured for pulling, when the compressed file is generated, the compressed file from the second server:

a decompressing sub-unit, configured for decompressing the compressed file to obtain the storage paths to be analyzed.

Optionally, in another embodiment of the present application, the first obtaining unit 301 is specifically configured for:

obtaining storage paths regularly sent by the junk cleaning APP in the electronic device as the storage paths to be analyzed.

Optionally, in the embodiment of the present application, the apparatus may also include:

a sending unit, configured for sending, after taking a resulting storage path obtained after filtering as a junk feature, the junk feature to the junk cleaning APP, so that the junk cleaning APP detects a file corresponding to the junk feature;

a second judging unit, configured for determining whether the size of the detected file increases;

a fourth obtaining unit, configured for taking, when the size of the detected file increases, the junk feature as a junk feature for deleting junk files.

Optionally, the target storage path may further include: a storage path matching file features in a preset black list.

Optionally, the file features in the preset black list may include: a preset cache identifier and a preset advertisement identifier.

Corresponding to the above method embodiment, an embodiment of the present application provides a server, as shown in FIG. 4, which comprises a processor 401, a communication interface 402, a memory 403 and a communication bus 404, wherein the processor 401, the communication interface 402, and the memory 403 communicate with each other via the communication bus 404,

the memory 403 is configured for storing a computer program;

the processor 401 is configured for implementing method steps of the junk feature acquisition method provided by any one of the foregoing method embodiments when executing a program stored in the memory 403.

The communication bus described with respect to the server above may be a peripheral component interconnect (PCI) bus or an extended industry standard architecture (EISA) bus, and the like. The communication bus can include an address bus, a data bus, a control bus, or the like. For representation, only one thick line is shown in the figure, which does not mean there is only one communication bus or one type of communication bus.

The communication interfaces are used for communication between the server described above and the apparatuses.

The memory may include a random access memory (RAM), or may include non-volatile memory (NVM), for example at least one disk memory. Optionally, the memory can also be at least one storage device located away from the processor described above.

The processor described above may be a general-purpose processor, such as a central processing unit (CPU), a network processor (NP), etc.; it may also be a digital signal processor (DSP), an application specific integrated circuit (ASIC), field-programmable gate array (FPGA) or other programmable logic devices, discrete gate or transistor logic devices, discrete hardware components.

The server provided in the embodiment of the present application obtains the storage paths to be analyzed, that is, the storage path of the file corresponding to the APP installed in the electronic device is obtained. Then a storage path matching the file features of the non-junk files in the preset white list are filtered out from the storage paths to be analyzed, and the resulting storage paths are considered to be the storage paths corresponding to the junk files. Since the junk files under the storage path can be found through the resulting storage path, the resulting storage path can be used as a junk feature, so that the obtained junk feature can be used later to find the corresponding junk files. In this way, the efficiency of acquiring junk feature is improved. In addition, the manpower consumption is reduced, thereby reducing the cost of obtaining junk features.

Corresponding to the above method embodiment, an embodiment of the present application further provides a readable storage medium. A computer program is stored in the readable storage medium, and the method steps of the junk feature acquisition method provided by any one of the foregoing method embodiments are implemented when the computer program being executed by a processor.

After the computer program stored in the readable storage medium provided by the embodiment of the present application is executed by the processor of the server, the storage paths to be analyzed may be obtained, that is, the storage path of the file corresponding to the APP installed in the electronic device is obtained. Then a storage path matching a file feature of a non-junk file in the preset white list are filtered out from the storage paths to be analyzed, and the resulting storage paths are considered to be the storage paths corresponding to the junk files. Since the junk files under the storage path can be found through the resulting storage path, the resulting storage path can be used as a junk feature, so that the obtained junk feature can be used later to find the corresponding junk files. In this way, the efficiency of acquiring junk feature is improved. In addition, the manpower consumption is reduced, thereby reducing the cost of obtaining junk features.

Corresponding to the above method embodiment, an embodiment of the present application further provides a computer program product containing instructions, which when executed on a server, causes the server to execute: the method steps of the junk feature acquisition method provided by any one of the foregoing method embodiments.

The computer program product containing instructions provided by the embodiment of the present application runs on the server, the server may obtain the storage to be analyzed, that is, the storage path of the file corresponding to the APP installed in the electronic device is obtained. Then a storage path matching a file feature of a non-junk file in the preset white list is filtered out from the storage paths to be analyzed, and the resulting storage path is considered to be the a storage path corresponding to the junk files. Since the junk files under the storage path can be found through the resulting storage path, the resulting storage path can be used as a junk feature, so that the obtained junk feature can be used later to find the corresponding junk files. In this way, the efficiency of acquiring junk feature is improved. In addition, the manpower consumption is reduced, thereby reducing the cost of obtaining junk features.

It should be noted that the relationship terms herein such as “first”, “second”, and the like are only used for distinguishing one entity or operation from another entity or operation, but do not necessarily require or imply that there is any actual relationship or order between these entities or operations. Moreover, the terms “include”, “comprise” or any other variants thereof are intended to cover non-exclusive inclusions, so that processes, methods, articles or devices comprising a series of elements comprise not only those elements listed but also those not specifically listed or the elements intrinsic to these processes, methods, articles, or devices. Without further limitations, elements defined by the sentences “comprise(s) a.” or “include(s) a.” do not exclude that there are other identical elements in the processes, methods, articles, or devices which include these elements.

All the embodiments are described in corresponding ways, same or similar parts in each of the embodiments can be referred to one another, and the parts emphasized are differences to other embodiments. For embodiments of the apparatus, server and readable storage medium, since they are similar to the embodiments of the method, the description thereof is relatively simple; the relating parts could refer to those in the description of embodiments of the method.

The embodiments described above are merely preferred embodiments of the present application, and not intended to limit the scope of the present application. Any modifications, equivalents, improvements or the like within the spirit and principle of the application should be included in the scope of the application.

1. A junk feature obtaining method applied to a first server, comprising:
obtaining storage paths to be analyzed; the storage paths to be analyzed comprise a storage path of a file corresponding to an application APP installed in an electronic device;
filtering out a target storage path from the storage paths to be analyzed, wherein the target storage path comprises: a storage path matching a file feature of a non-junk file in a preset white list;
taking a resulting storage path obtained after filtering as a junk feature.

2. The method of claim 1, wherein the file feature in the preset white list is: a file feature of a file that ensures the normal operation of a preset APP; the step of taking a resulting storage path obtained after filtering as a junk feature comprises:
determining whether the resulting storage path carries a preset APP identifier of the preset APP;
if the resulting storage path carries a preset APP identifier, taking the resulting storage path carrying the preset APP identifier as a junk feature corresponding to the preset APP.

3. The method of claim 2, wherein after the step of obtaining the storage paths to be analyzed, the method further comprises:
acquiring a model identifier of the electronic device corresponding to the storage paths to be analyzed, and storing the model identifier in correspondence with the storage paths to be analyzed;
the step of taking the resulting storage path carrying the preset APP identifier as a junk feature corresponding to the preset APP comprises:
determining a target model identifier corresponding to the resulting storage path carrying the preset APP identifier;
taking the resulting storage path carrying the preset APP identifier as: a junk feature corresponding to the preset APP in an electronic device corresponding to the target model identifier;
or
wherein if it is determined that the resulting storage path does not carry the preset APP identifier of the preset APP, the method further comprises:
determining a target APP identifier carried in the resulting storage path;
determining whether the number of occurrences of the resulting storage path carrying the target APP identifier exceeds a preset number of occurrences;
if it exceeds the preset number of occurrences, adding a target file feature into the preset white list; wherein the target file feature is a file feature of a file that ensures the normal operation of a target APP corresponding to the target APP identifier.

4. (canceled)

5. The method of claim 1, wherein the step of obtaining the storage paths to be analyzed comprises:
obtaining sub-storage paths under a preset storage path in the electronic device; the preset storage path is: an installation path of the APP in the electronic device;
taking the obtained sub-storage paths as the storage paths to be analyzed.

6. The method of claim 5, wherein the step of taking the obtained sub-storage paths as storage paths to be analyzed comprises:
pre-processing the obtained sub-storage paths based on a pre-processing rule to obtain pre-processed sub-storage paths; wherein, the pre-processing rule comprises: performing deduplication of a sub-storage path that repeatedly occurs, and/or, filtering out a sub-storage path containing a preset language text from the sub-storage paths;
taking the pre-processed sub-storage paths as the storage paths to be analyzed.

7. The method of claim 1, wherein the step of obtaining the storage paths to be analyzed comprises:
monitoring whether a compressed file is generated by a second server; wherein the compressed file is obtained by compressing the storage paths to be analyzed;
if the compressed file is generated, pulling the compressed file from the second server;
decompressing the compressed file to obtain the storage paths to be analyzed;
or
wherein the step of obtaining the storage paths to be analyzed comprises:
obtaining storage paths regularly sent by the junk cleaning APP in the electronic device as the storage paths to be analyzed.

8. (canceled)

9. The method of claim 7, wherein after the step of taking a resulting storage path obtained after filtering as a junk feature, the method further comprises:
sending the junk feature to the junk cleaning APP, so that the junk cleaning APP detects a file corresponding to the junk feature based on the junk feature;
determining whether the size of a file corresponding to the junk feature detected based on the junk feature increases;
if the size increases, taking the junk feature as an effective junk feature.

10. The method of claim 1, wherein the target storage path further comprises a storage path matching file features in a preset black list.

11. The method of claim 10, wherein the file features in the preset black list comprise: a preset cache identifier and a preset advertisement identifier.

12. A junk feature obtaining apparatus, applied to a first server, comprising:
a first obtaining unit, configured for obtaining storage paths to be analyzed; the storage paths to be analyzed comprise a storage path of a file corresponding to an application APP installed in an electronic device;
a filtering unit, configured for filtering out a target storage path from the storage paths to be analyzed, wherein the target storage path comprises: a storage path matching a file feature of a non-junk file in a preset white list;
a second obtaining unit, configured for taking a resulting storage path obtained after filtering as a junk feature.

13. The apparatus of claim 12, wherein the file feature in the preset white list is: a file feature of a file that ensures the normal operation of a preset APP; the second obtaining unit comprises:
a first judging sub-unit, configured for determining whether the resulting storage path carries a preset APP identifier of the preset APP;
a first obtaining sub-unit, configured for taking, when the resulting storage path carries a preset APP identifier, the resulting storage path carrying the preset APP identifier as a junk feature corresponding to the preset APP.

14. The apparatus of claim 13, further comprising:
a third obtaining unit, configured for acquiring, after obtaining the storage paths to be analyzed, a model identifier of the electronic device corresponding to the storage paths to be analyzed, and storing the model identifier in correspondence with the storage paths to be analyzed;
the second obtaining unit is specifically configured for:
determining a target model identifier corresponding to the resulting storage path carrying the preset APP identifier;
taking the resulting storage path carrying the preset APP identifier as: a junk feature corresponding to the preset APP in an electronic device corresponding to the target model identifier;
or
the apparatus further comprises:
a first determining unit, configured for determining, when it is determined that the resulting storage path does not carry the preset APP identifier of the preset APP, a target APP identifier carried in the resulting storage path;
a first judging unit, configured for determining whether the number of occurrences of the resulting storage path carrying the target APP identifier exceeds a preset number of occurrences;
an adding unit, configured for adding, when the number of occurrences of the resulting storage path carrying the target APP identifier exceeds the preset number of occurrences, a target file feature into the preset white list; wherein the target file feature is a file feature of a file that ensures the normal operation of a target APP corresponding to the target APP identifier.

15. (canceled)

16. The apparatus of claim 12, wherein the first obtaining unit comprises:
a second obtaining sub-unit, configured for obtaining sub-storage paths under a preset storage path in the electronic device; the preset storage path is: an installation path of the APP in the electronic device;
a second obtaining sub-unit, configured for taking the obtained sub-storage paths as the storage paths to be analyzed.

17. The apparatus of claim 16, wherein the second obtaining sub-unit is specifically configured for:
pre-processing the obtained sub-storage paths based on a pre-processing rule to obtain pre-processed sub-storage paths; wherein, the pre-processing rule comprises: performing deduplication of a sub-storage path that repeatedly occurs, and/or, filtering out a sub-storage path containing a preset language text from the sub-storage paths;
taking the pre-processed sub-storage paths as the storage paths to be analyzed.

18. The apparatus of claim 12, wherein the first obtaining unit comprises:
a monitoring sub-unit, configured for monitoring whether a compressed file is generated by a second server; wherein the compressed file is obtained by compressing the storage paths to be analyzed;
a pulling sub-unit, configured for pulling, when the compressed file is generated, the compressed file from the second server;
a decompressing sub-unit, configured for decompressing the compressed file to obtain the storage paths to be analyzed;
or
wherein the first obtaining unit is specifically configured for:
obtaining storage paths regularly sent by the junk cleaning APP in the electronic device as the storage paths to be analyzed.

19. (canceled)

20. The device of claim 18, further comprising:
a sending unit, configured for sending, after taking a resulting storage path obtained after filtering as a junk feature, the junk feature to the junk cleaning APP, so that the junk cleaning APP detects a file corresponding to the junk feature;
a second judging unit, configured for determining whether the size of the detected file increases;
a fourth obtaining unit, configured for taking, when the size of the detected file increases, the junk feature as a junk feature for deleting junk files.

21. The apparatus of claim 12, wherein the target storage path further comprises a storage path matching file features in a preset black list.

22. The apparatus of claim 21, wherein the file features in the preset black list comprise: a preset cache identifier and a preset advertisement identifier.

23. A server, comprising a processor, a communication interface, a memory and a communication bus; and the processor, the communication interface and the memory communicate with each other via the communication bus;
the memory is used for storing a computer program;
the processor is used for performing the steps of the method of claim 1 when executing the program stored on the memory.

24. A non-transitory storage medium, wherein the readable storage medium stores a computer program therein, and the steps of the method of claim 1 are implemented when the computer program being executed by a processor.

25. (canceled)
